(19) United States
(12) Patent Application Publication
(10) Pub. No.: US 2016/0055154 A1
(43) Pub. Date: Feb. 25, 2016

(54) Computer Implemented System and Method for Identifying Product Images Based Refined Color Histograms

(71) Applicants: Chuck Surack, Fort Wayne, IN (US); John Hopkins, Fort Wayne, IN (US); Michael Ross, Fort Wayne, IN (US); Mike Clem, Grabill, IN (US); Greg Wardwell, Columbia City, IN (US); Dan Schafer, Fort Wayne, IN (US)

(72) Inventors: Chuck Surack, Fort Wayne, IN (US); John Hopkins, Fort Wayne, IN (US); Michael Ross, Fort Wayne, IN (US); Mike Clem, Grabill, IN (US); Greg Wardwell, Columbia City, IN (US); Dan Schafer, Fort Wayne, IN (US)

(21) Appl. No.: 14/465,868

(22) Filed: Aug. 22, 2014

(51) Int. Cl. G06F 17/30; G06T 7/00

(52) U.S. Cl. CPC G06F 17/3025; G06T 7/0079

(57) ABSTRACT

A computer implemented method for searching an electronic database of product images, said method comprising the steps of: accessing a plurality of digital images of each of a plurality of products; segregating said images by color and product type; calculating the number of pixels for each color in each of said product images; dividing said colors into a plurality of discrete segments within the visible color spectrum; averaging the number of pixels for each color for each said image of a single product; applying a multiplier to blocks that exist within a cohesive quantized color group; normalizing said pixel count based on the percentage of the number of pixels within a predetermined range; storing said histogram into a database wherein each discrete segment has one value within the visual spectrum; and sorting the histograms in order of highest percentage of each color in the profile to lowest.

### BACKGROUND

1. Field of the Art

The present invention relates generally to a computer implemented system and method for creating and utilizing coherent color histograms. More specifically, the present invention relates to a system and method for creating and using coherent color histograms to allow system users to perform high precision searches based on color.

2. Description of the Prior Art

Many applications require simple methods for comparing pairs of images based on their overall appearance. For example, a user may wish to retrieve all images similar to a given image from a large database of images. Color histograms are a popular solution to this problem. Color histograms are computationally efficient, and generally insensitive to small changes in camera position. However, a color histogram provides only a very coarse characterization of an image; images with similar histograms can have dramatically different appearances. For example, a picture of fall foliage might contain a large number of scattered red pixels; this could have a similar color histogram to a picture with a single large red object.

In comparing images using color coherence vectors published by Cornell University, the authors describe a histogram-based method for comparing images that incorporates spatial information. Each pixel in a given color bucket is classified as either coherent or incoherent, based on whether or not it is part of a large similarly-colored region. A color coherence vector (“CCV”) stores the number of coherent versus incoherent pixels with each color. By separating coherent pixels from incoherent pixels, CCV's provide finer distinctions than color histograms.

The methods described by the authors are often used in computer programs such as search engines to allow users to search for specific products within a group of items based on color especially within the webpage of Internet based retailers. Unfortunately, when product photographs are taken color inconsistencies due to day to day variance in photography and lighting often manifest between products within a series or from series to series of the same products. Over time, these inconsistencies negatively impact the ability of the system to distinguish specific colors which prevents online shoppers from having the ability to select products based on as broad a group of potential color choices as possible or to differentiate between different colors that are nevertheless close in wavelength. Thus, there is a need for a computer implemented system and method for creating and using coherent color histograms to allow system users to perform high precision searches based on color. Preferably, such a system will adapt over time by removing images of low quality or that inaccurately represent the desired product or color.

### SUMMARY

The method of the present invention comprises, in one exemplary embodiment, a computer implemented method for searching an electronic database of product images, said method comprising the steps of: accessing a plurality of digital images of each of a plurality of products; segregating said images by color and product type; calculating the number of pixels for each color in each of said product images; dividing said colors into a plurality of discrete segments within the visible color spectrum; averaging the number of pixels for each color for each said image of a single product; applying a multiplier to blocks that exist within a cohesive quantized color group; normalizing said pixel count based on the percentage of the number of pixels within a predetermined range; storing said histogram into a database wherein each discrete segment has one value within the visual spectrum; and sorting the histograms in order of highest percentage of each color in the profile to lowest.

### BRIEF DESCRIPTION OF THE DRAWINGS

The present invention will be understood more fully from the detailed description given hereinafter and from the accompanying drawings of the preferred embodiment of the present invention, which, however, should not be taken to limit the invention, but are for explanation and understanding only.

In the drawings:

FIG. 1 shows a functional block diagram of an exemplary prior art computer network for use with the present invention.

FIG. 2 shows a functional block diagram of an exemplary prior art computing device for use with the present invention.

FIG. 3 shows an illustrative block diagram of an exemplary prior art mobile computing device for use with the present invention.

FIG. 4 shows a table of histograms as may be produced and used with the present invention.

FIG. 5 shows a software flow chart of an exemplary method according to the present invention.

### DETAILED DESCRIPTION OF THE EMBODIMENTS

The present invention will be discussed hereinafter in detail in terms of the preferred embodiment according to the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to avoid unnecessary obscuring of the present invention.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations.

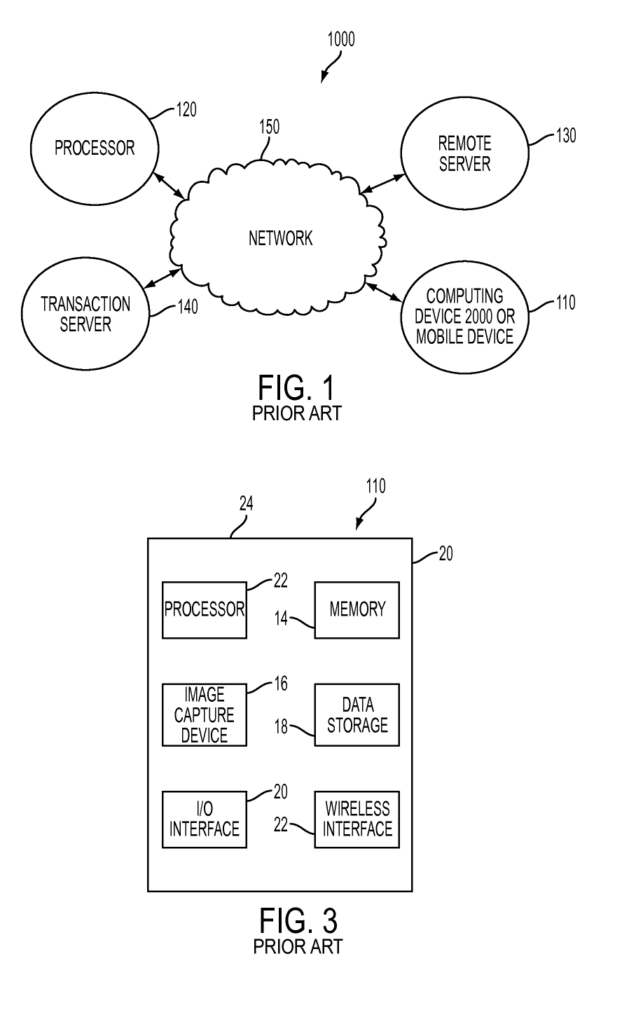

All of the implementations described below are exemplary implementations provided to enable persons skilled in the art to make or use the embodiments of the disclosure and are not intended to limit the scope of the disclosure, which is defined by the claims. In the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Moreover, the terms “computer program medium” and “computer usable medium” are used to generally refer to physical storage media such as, RAM, ROM, a hard drive, or other memory storage device. These and other various forms of computer program media or computer usable media may store one or more sequences of one or more instructions to a processing device for execution. Such instructions embodied on the medium, are generally referred to as “computer program code” or a “computer program product” (which may be grouped in the form of computer programs or other groupings). When executed, such instructions may enable the computing module to perform features or functions of the present invention as discussed herein.

As used herein, the term “module” may describe a given unit of functionality that can be performed. As used herein, a module may use any form of hardware, software, or a combination thereof. A module can include one or more processors, controllers, ASICs, PLAs, logical components, software routines or other mechanisms. Any module described herein may be used as discrete modules or the functions and features described can be shared in part or in total among one or more modules.

Turning first to FIG. 1, there is shown a functional block diagram of an exemplary computer communication system for use with the present invention. As shown in FIG. 1, system 1000 generally comprises: at least one computing device 2000, at least one computer processor 120, a remote server 130, and a transaction server 140, and a communication network 150, such as the Internet.

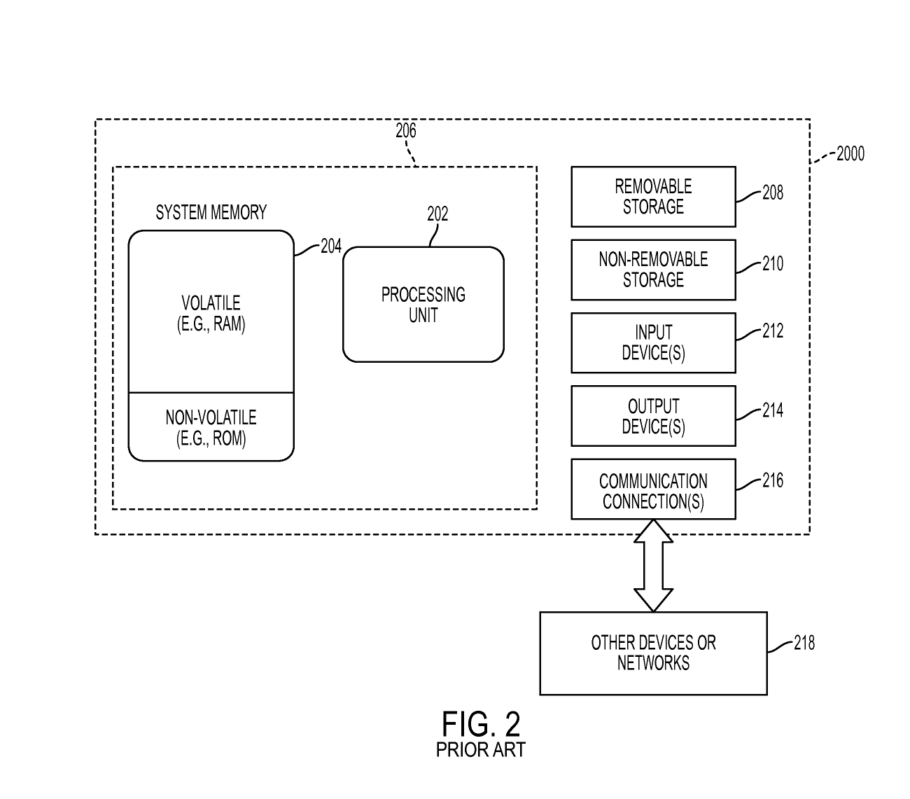

Referring next to FIG. 2, there is shown a functional block diagram generally illustrating a computing device 2000, one or more of which may be adapted for use in the illustrative system for implementing the invention. The computing device may be, for example, a personal computer, a handheld device such as a cell phone, tablet or a personal digital assistant, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

In its most basic configuration, computing device 2000 typically includes at least one processing unit 202 and system memory 204. Depending on the exact configuration and type of computing device, system memory 204 may be volatile (such as RAM), non-volatile (such as ROM, flash memory, etc.) or some combination of the two. The basic configuration of the device 2000 is illustrated in FIG. 2 within dashed line 206.

Device 2000 may also have additional features and functionality. For example, device 2000 may also include additional storage (removable and/or non-removable) including, but not limited to, magnetic or optical disks or tape. Such additional storage is illustrated in FIG. 1 by removable storage 208 and non-removable storage 210. Computer storage media includes volatile and nonvolatile, removable and non-removable media implemented in any method or technology for storage of information such as computer readable instructions, data structures, program modules, or other data. System memory 204, removable storage 208, and non-removable storage 210 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by device 2000. Any such computer storage media may be part of device 2000.

Device 2000 includes one or more input devices 212 such as a keyboard, mouse, pen, puck, voice input device, touch input device, scanner, or the like. One or more output devices 214 may also be included, such as a video display, audio speakers, a printer, or the like. Input and output devices are well known in the art and need not be discussed at length here.

Device 2000 also contains communications connection 216 that allows the device 2000 to communicate with other devices 218, such as over a local or wide area network. Communications connection 216 is one example of communication media. Communication media includes any information delivery media that serves as a vehicle through which computer readable instructions, data structures, program modules, or other data may be delivered on a modulated data signal, such as a carrier wave or other transport mechanism. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, electromagnetic (e.g., radio frequency), infrared, and other wireless media. The term computer readable media as used herein includes both storage media and communication media.

Turning now to FIG. 3, there is shown an illustrative block diagram of an exemplary prior art mobile device 110, such as a smart phone, tablet computer, notebook computer, laptop computer, or the like for use with one or more aspects of the present invention. Mobile device 110 may be used in place of computing device 2000 in FIG. 1. As shown in FIG. 3, mobile device 110 generally comprises a processor 12, a memory storage device 14, an image capture device 16, a data storage device 18, a plurality of input/output interfaces 20, and a wireless communication interface 22, where all of these components are in electronic communication with one another and contained within a physical housing 24.

Mobile device 110 includes a mobile processor 12. Mobile processor 12 can be a microprocessor or the like that is configurable to execute program instructions stored in mobile memory 14 and/or the mobile data storage 18. Mobile memory 14 is a computer-readable memory that stores data and/or computer program instructions for execution by processor 12. Mobile memory 14 can include volatile memory, such as RAM and/or persistent memory, such as flash memory. Mobile data storage 18 is a computer readable storage medium that can be used to store data and or computer program instructions. Mobile data storage 18 includes a hard drive, flash memory, a SD card, and other types of data storage.

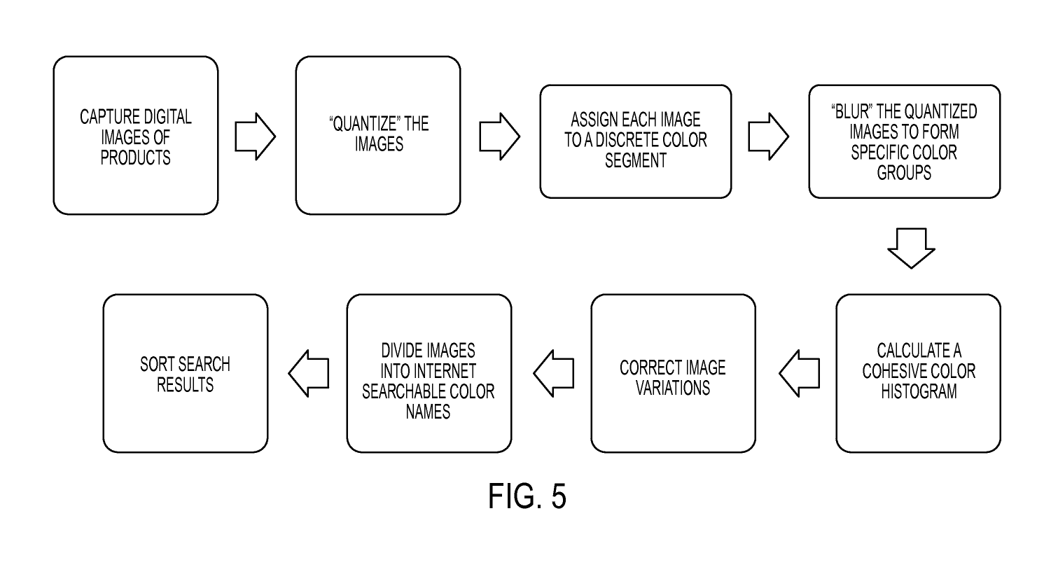

Referring now to FIG. 5, there is shown a software flow chart of an exemplary method according to the present invention. A plurality of digital product images is stored on one or more servers within system 1000 as shown in FIG. 1. In a first step of the method of present invention, the digital product images are captured and “quantized,” which means that, the images within each product group are separated segmented into 512 discrete color categories (or segments) using an adaptive color quantizing method. However, those of skill in the art will appreciate that more or less discrete segments may be used. In a preferred embodiment of the present invention, more segmentation is used for “normal” colors (less space per segment), and less segmentation is used towards black and white (more space per segment). Transparent pixels are ignored. On average, the division of segments is even across the red, green, and blue color spectra. Quantized images appear darker because each image is categorized by its darkest color.

Referring still to FIG. 5, the quantized product images are next blurred so that each color matches one of the 512 discrete color categories by averaging blocks of pixels into single large blocks of particular colors. These blocks are then defined as specific color groups. Care is taken to insure that these groups of specific color are differentiated from other adjacent and optionally semi or near adjacent similar colors.

Referring again to FIG. 5, the next step of the present inventive method is to calculate a cohesive color histogram. This step in the present inventive method comprises counting the number of pixels devoted to each color space and defining a color histogram. A computer to differentiates between vastly different visual images with similar unrefined color histograms by applying a multiplier to blocks that exist within a cohesive quantized color group. The number of pixels counted is normalized based on the percentage of the number of overall blurred blocks (preferably between 0-255). The newly created histogram is then stored into a database within system 1000 as a color profile for a particular product group, product type, or series within a product.

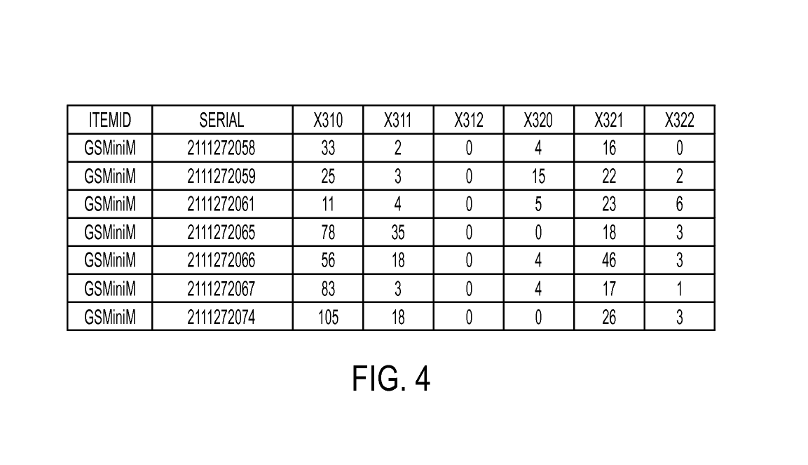

As illustrated in FIG. 4, in a preferred embodiment, each product has a product ID and serial number combination. The coherent color histogram developed by the present method has one value per discrete segment of the RGB color space. The histograms may vary from serial to serial as shown in the table of FIG. 4.

Continuing to refer to FIG. 5, the method of the present invention further comprises dividing the quantized images of products listed by product ID and serial no. in FIG. 4 into Internet searchable web colors (x 310 through x 322 in FIG. 5). As previously discussed herein, each serialized color profile can vary due to differences in product quality, ambient conditions when the image is taken, and day to day variance in photography and lighting. To correct for these variations, the method of the present invention comprises averaging the histogram color profile of the most recent images for a product where the average is weighted towards the most recent images. For example, if at least 10 profiles exist, 10% of the data is removed to remove the statistical outliers. In the preferred embodiment of the present invention, the averaged data is divided into 12 web-selectable colors (ie. Red, blue, green, etc.), that can be searched by a user. These color groups are selected based on characteristics of human perception of color. Users of the system can then perform computerized searches for items of a specific color wherein the results returned by the search have at least a minimum value (hand-tuned to our products) in their web color profile for that color. Search results are sorted in order of highest percentage of the selected color in the profile to lowest.

The above-described embodiments are merely exemplary illustrations set forth for a clear understanding of the principles of the invention. Many variations, combinations, modifications, or equivalents may be substituted for elements thereof without departing from the scope of the invention. It should be understood, therefore, that the above description is of an exemplary embodiment of the invention and included for illustrative purposes only. The description of the exemplary embodiment is not meant to be limiting of the invention. A person of ordinary skill in the field of the invention or the relevant technical art will understand that variations of the invention are included within the scope of the claims.

1. A computer implemented method for searching an electronic database of product images, said method comprising the steps of: accessing a plurality of digital images of each of a plurality of products; segregating said images by color and product type; calculating the number of pixels of each color in each of said product images; dividing said colors into a plurality of discrete segments within the visible color spectrum; averaging the number of pixels for each color for each said image of a single product; creating a histogram from said pixel count based on the percentage of the number of pixels within a predetermined range; storing said histogram into a database wherein each discrete color segment has one value within the visual spectrum; sorting the histograms in order of percentage of each color.
